(19) United States
(12) Patent Application Publication
(10) Pub. No.: US 2018/0213201 A1
(43) Pub. Date: Jul. 26, 2018

(54) GENERATING A DISPARITY MAP BASED ON STEREO IMAGES OF A SCENE

(71) Applicant: Heptagon Micro Optics Pte. Ltd., Singapore (SG)

(72) Inventors: Chi Zhang, Freemont, CA (US); Alireza Yasan, San Jose, CA (US); Xin Liu, Sunnyvale, CA (US); Florin Cutu, San Jose, CA (US); Dmitry Ryuma, San Francisco, CA (US)

(21) Appl. No.: 15/745,150

(22) PCT Filed: Jul. 13, 2016
(86) PCT No.: PCT/SG2016/050329

§ 371 Date: Jan. 16, 2018

Related U.S. Application Data
(60) Provisional application No. 62/194,973, filed on Jul. 21, 2015.

(51) Int. Cl. H04N 13/00; G06T 7/00; G06K 9/62

(52) U.S. Cl. CPC H04N 13/0022; G06T 7/97; G06T 2207/10012; H04N 2013/0081; G06K 9/6212

(57) ABSTRACT

Providing a disparity map includes acquiring first and second stereo images, binarizing the first stereo image to obtain a binarized image, and applying a block matching technique to the first and second stereo images to obtain an initial disparity map in which individual image elements are assigned a respective initial disparity value. For each respective image element, an updated disparity value that represents a product of the initial disparity value assigned to the image element and a value associated with the image element in the binarized image is obtained. An updated disparity map can be generated and represents the updated disparity values of the image elements.

### TECHNICAL FIELD

This disclosure relates to image processing and, in particular, to systems and techniques for generating a disparity map based on stereo images of a scene.

### BACKGROUND

Various image processing techniques are available to find depths of a scene in an environment using image capture devices. The depth data may be used, for example, to control augmented reality, robotics, natural user interface technology, gaming and other applications.

Block-matching is an example of a stereo-matching process in which two images (a stereo image pair) of a scene taken from slightly different viewpoints are matched to find disparities (differences in position) of image elements which depict the same scene element. The disparities provide information about the relative distance of the scene elements from the camera. Stereo matching enables disparities (i.e., distance data) to be computed, which allows depths of surfaces of objects of a scene to be determined A stereo camera including, for example, two image capture devices separated from one another by a known distance can be used to capture the stereo image pair.

In a typical block matching technique, the reference image must be scanned Such scanning can be relatively time-consuming and can require significant computational power, thus making real-time or near-real time applications difficult to achieve. Further, some regions of the reference image that are scanned may not have sufficient texture or other features to be used for matching purposes. This can result in wasted or unnecessary steps in the computational process.

### SUMMARY

The present disclosure describes techniques for rapidly generating a disparity map for image elements (e.g., pixels) of an image capture device. In particular, the pixels that contain useful information (e.g., texture) are used to generate a binarized image. In addition, an initial (blocky) disparity map, which can be accomplished relatively quickly, is generated. The disparity values in the initial disparity map then can be assigned to image elements in the binarized image so as to obtain an updated disparity map.

For example, in one aspect, the disclosure describes a method of providing a disparity map. The method includes acquiring first and second stereo images, binarizing the first stereo image to obtain a binarized image, and applying a block matching technique to the first and second stereo images to obtain an initial disparity map in which individual image elements are assigned a respective initial disparity value. The method further includes obtaining, for each respective image element, an updated disparity value that represents a product of the initial disparity value assigned to the image element and a value associated with the image element in the binarized image. An updated disparity map is generated and represents the updated disparity values of the image elements.

According to another aspect, an apparatus for providing a disparity map includes first and second image capture devices to acquire, respectively, first and second stereo images. An image binarization engine is operable to binarize the first stereo image to obtain a binarized image. A block matching engine is operable to apply a block matching technique to the first and second stereo images to obtain an initial disparity map, in which individual image elements are assigned a respective initial disparity value. The block matching engine also is operable to obtain, for each respective image element, an updated disparity value that represents a product of the initial disparity value assigned to the image element and a value associated with the image element in the binarized image. An updated disparity map generation engine is operable to generate an updated disparity map representing the updated disparity values of the image elements.

Some implementations include one or more of the following features. For example, the updated disparity map can be displayed on a display device, wherein different disparity values are represented by different visual indicators. In some instances, the updated disparity map is displayed as a three-dimensional color image, wherein different colors are indicative of different disparity values.

In some cases, obtaining, for each respective image element, an updated disparity value includes (i) for each pixel having a value of 1 in the binarized image, assigning the initial disparity value to that pixel; and (ii) for each pixel having a value of 0 in the binarized image, assigning a disparity value of 0 to that pixel or assigning no disparity value to that pixel.

The block matching technique can includes, in some implementations, comparing blocks of image elements in the first image to blocks of image elements in the second image, and identifying, for each block in the first image, a respective closest matching block in the second image. In some cases, the first and second images are of a scene, and the block matching technique uses a block size that is scaled based on a size or pitch of optical features projected onto the scene. Further, identifying a closest match for a particular block in the first image can include, for example, selecting a block of the second image having the lowest sum of absolute differences value with respect to the particular block.

In some implementations, the various engines may be implemented in hardware (e.g., one or more processors or other circuitry) and/or software.

Various implementations can provide one or more of the following advantages. For example, some implementations can help generate a relatively accurate disparity map more quickly relative to some other stereo-matching techniques. Thus, the present techniques can be applied to real-time or near-real time applications in which a disparity map needs to be displayed.

Other aspects, features and advantages will be readily apparent from the following detailed description, the accompanying drawings and the claims.

### BRIEF DESCRIPTION OF THE DRAWINGS

FIG. 1 is an example of a system for generating a disparity map using stereo images.

FIG. 2 is a flow chart of a method for generating a disparity map using stereo images.

FIG. 3 is a flow chart illustrating an example of a block matching technique.

FIG. 4 is a flow chart illustrating an example of combining a binarized image and an initial disparity map to obtain an updated disparity map.

### DETAILED DESCRIPTION

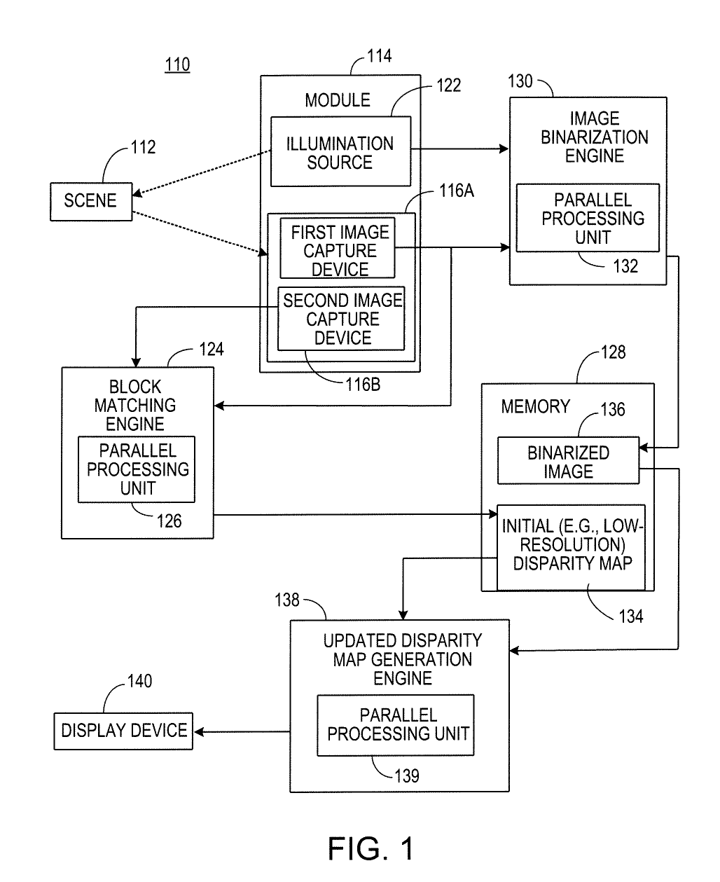

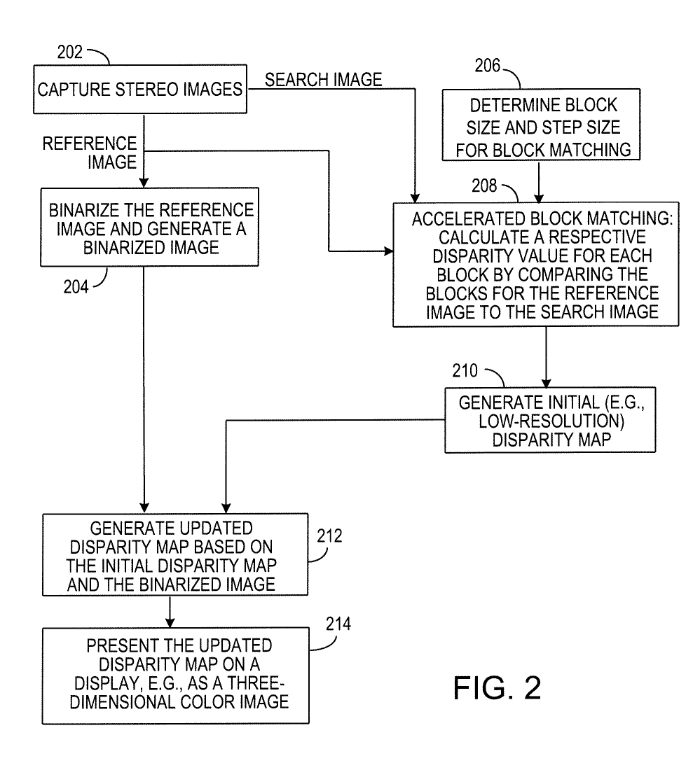

FIG. 1 illustrates an example of a system 110 for generating a disparity map based on captured stereo images of a scene 112, which includes one or more objects. The system can include an optoelectronic module 114 that captures stereo image data of a scene (see also FIG. 2, block 202). For example, the module 114 can have two or more stereo image capture devices 116A, 116B (e.g., CMOS image sensors or CCD image sensors) to acquire images of the scene 112. An image acquired by a first one of the stereo imagers 116A is used as a reference image; an image acquired by a second one of the stereo imagers 116B is used as a search image.

In some cases, the module 114 also may include an associated illumination source 122 arranged to project a pattern of illumination onto the scene 112. When present, the illumination source 122 can include, for example, an infra-red (IR) projector, a visible light source or some other source operable to project a pattern (e.g., of dots or lines) onto objects in the scene 112. The illumination source 122 can be implemented, for example, as a light emitting diode (LED), an infra-red (IR) LED, an organic LED (OLED), an infra-red (IR) laser or a vertical cavity surface emitting laser (VCSEL). The projected pattern of optical features can be used to provide texture to the scene to facilitate stereo matching processes between the stereo images acquired by the devices 116A, 116B.

The reference image acquired by the first image capture device 116A is provided to an image binarization engine 130, which generates a binarized version 136 of the reference image (FIG. 2, block 204). In the binarized version of the image 136, each pixel of the reference image is assigned one of two possible values. For example, background pixels (i.e., pixels containing no texture) can be assigned a value of “0,” whereas pixels containing texture can be assigned a value of “1.” Thus, the image binarization engine 130 generates a bi-level image, in which pixels containing useful information (e.g., texture) are assigned one value, and pixels containing only background information are assigned a different value. The binarized image 136 can be stored, for example, in memory 128. The image binarization engine 130 can be implemented, for example, using a computer and can include a parallel processing unit 132 (e.g., an application specific integrated circuit (ASIC) or a field programmable gate array (FPGA)). In other instances, the image binarization engine 130 can be implemented with software (e.g., via the mobile/smartphone processor).

In some implementations, the image binarization engine 130 executes an un-sharp masking algorithm, which is an image sharpening tool that can improve the definition of fine detail by removing low-frequency spatial information from the original image. In particular, the un-sharp masking algorithm involves subtracting an un-sharp mask from the original image. The un-sharp mask is a blurred image that is produced by spatially filtering the original image with a Gaussian low-pass filter. In some implementations, other techniques may be used to generate the binarized image 136.

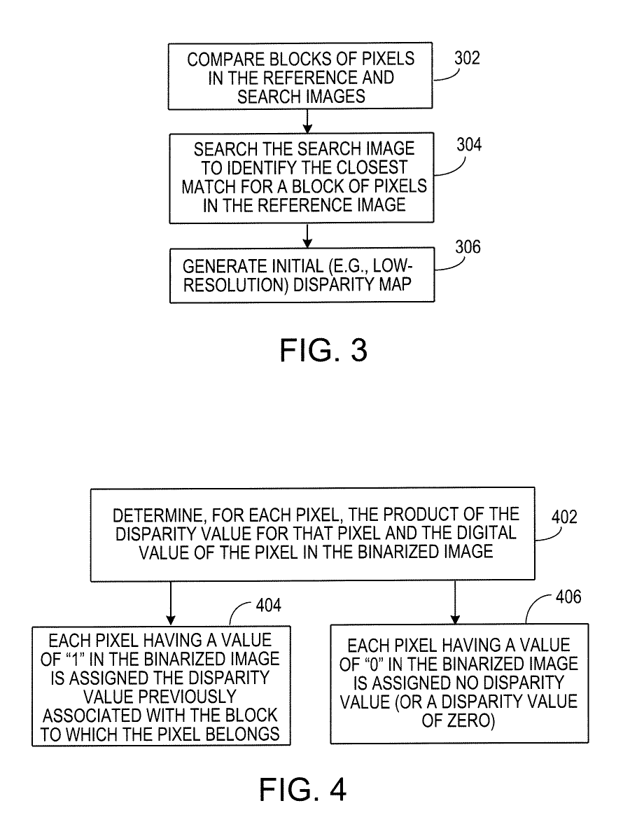

The reference image and search image acquired by the image capture devices 116A, 116B are provided to a block matching engine 124 (FIG. 1), which executes an accelerated block-matching algorithm (FIG. 2, block 208). In the block matching algorithm, disparity information can be calculated by computing the distance in pixels between the location of a block of pixels in the reference image and the location of the same, or substantially same, block in the search image. Thus, as indicated by FIG. 3, by comparing blocks of image elements (e.g., pixels) in the reference and search images (block 302), the block matching engine searches the search image to identify the closest match for a block of pixels in the reference image (block 304). The block matching engine 124 can be implemented, for example, using a computer and can include a parallel processing unit 126 (e.g., an application specific integrated circuit (ASIC) or a field programmable gate array (FPGA)). In other instances, the block matching engine 124 can be implemented with software (e.g., via the mobile device/smartphone processor).

Preferably, a block size and step size are determined for use in the block-matching technique implemented by the block matching engine 124 (see FIG. 2, block 206). The block size refers to the dimensions (i.e., width and height) of each block of pixels in the reference and search images that are compared to one another. Savings in processing time can be achieved by using relatively large block size and/or step size. For example, in some instances the step size can be substantially equal to the size of the block such that the blocks extracted from the reference image are tiled with respect to each other. In instances where the step size is equal to the block size (that is, tiled blocks in the reference image), block matching can be accelerated by the square of the block size. However, in other instances, the step size may be substantially less than the size of the block such that the blocks extracted from the reference image overlap with respect to each other. In either case, the blocks can be scanned through the search image by column- and row-sized steps in accordance with typical block-matching algorithms. Nevertheless, in some instances, the block size is scaled based on the size or pitch of the features (i.e., the dots, lines or other features) projected onto the scene 112 by the illumination source 122. Scaling the block size in this manner can be useful because, in situations where the texture is provided by the features projected by the illumination source 122, depth resolution cannot be increased by using ever smaller block sizes. Thus, in some instances, the block size is substantially equal to the pitch of the features projected onto the scene 112 by the illumination source 122. For some implementations, a dot pitch of twelve pixels and a block size of twelve to fifteen pixels can be advantageous. The step size can vary depending on the implementation. In some cases, the step size is equal to the block width. In other cases, for example, to increase lateral resolution, the step size may be smaller than the block width. Determination of the block size and step size can be performed by the block matching engine 124.

Various techniques can be used to determine how similar blocks in the two images are, and to identify the closest match. One such known technique is the “sum of absolute differences,” sometime referred to as “SAD.” To compute the sum of absolute differences, a grey-scale value for each pixel in the reference block is subtracted from the grey-scale value of the corresponding pixel in the search block, and the absolute value of the differences is calculated. Then, all the differences are summed to provide a single value that roughly measures the similarity between the blocks. A lower value indicates the blocks are more similar. To find the block that is “most similar” to the template, the SAD values between the template and each block in the search image is computed, and the block in the search image with the lowest SAD value is selected. A respective disparity value then is assigned to each block of the reference image, where the disparity value refers to the distance between the centers of the matching blocks in the two images. In other implementations, other matching techniques may be used to generate the initial disparity map. In any event, the output of the block matching engine 124 is an initial (e.g., blocky) disparity map 134 in which each pixel of the reference image (or search image) is assigned a disparity value corresponding to the disparity value of the block to which it belongs (FIG. 2, block 210; FIG. 3, block 306).

Once the binarized image 136 and the initial disparity map 134 have been generated, they are provided to an updated disparity generation engine 138, which generates an updated disparity map (FIG. 2, block 212). In particular, the engine 138 determines, for each pixel, the product of the disparity value for that pixel and the digital value of the pixel in the binarized image (block 402). Thus, each pixel having a value of “1” in the binarized image is assigned the disparity value previously associated with the block to which the pixel belongs (block 404). On the other hand, each pixel having a value of “0” in the binarized image is assigned a disparity value of zero, which is equivalent to having no disparity value assigned (block 406). The resulting updated disparity map can be generated quickly and can be less blocky relative to the initial disparity map 134.

The updated disparity generation engine 138 can be implemented, for example, using a computer and can include a parallel processing unit 139 (e.g., an application specific integrated circuit (ASIC) or a field programmable gate array (FPGA)). In other instances, the disparity generation engine 138 can be implemented with software (e.g., via the mobile device/smartphone processor). Although the various engines 124, 130, 138 and memory 128 are shown in FIG. 1 as being separate from the module 114, in some implementations they may be integrated as part of the module 114. For example, the engines 124, 130, 138 and memory 128 may be implemented as one or more integrated circuit chips mounted on a printed circuit board (PCB) within the module 114, along with the image capture devices 116A, 116B. In some cases, the illumination source 122 (if present) may be separate from the module 114 that houses the image capture devices 116A, 116B. Further, the module 114 also can include other processing and control circuitry to control, for example, the timing of when the image capture devices 116A, 116B acquire images. Such circuitry also can be implemented, for example, in one or more integrated circuit chips mounted on the same PCB as the image capture devices 116.

The updated disparity map generated by the engine 138 can be provided to a display device 140, which graphically presents the updated disparity map, for example, as a three-dimensional color image. (FIG. 2, block 214). Thus, different disparity values (or ranges of values) can be converted and represented graphically by different, respective colors. In some implementations, different disparity values are represented graphically on the disparity map by different cross-hatching or other visual indicators.

The techniques described here may be suitable, in some cases, for real-time applications in which the output of a computer process (i.e., rendering) is presented to the user such that the user observes no appreciable delays that are due to computer processing limitations. For example, the techniques may be suitable for real-time applications on the order of about at least 30 frames per second or near real-time applications on the order of about at least 5 frames per second.

In some implementations, the disparity map can be used as input for distance determination. For example, in the context of the automotive industry, the disparity map can be used in conjunction with image recognition techniques that identify and/or distinguish between different types of objects (e.g., a person, animal, or other object) appearing in the path of the vehicle. The nature of the object (as determined by the image recognition) and its distance from the vehicle (as indicated by the disparity map) may be used by the vehicle's operating system to generate an audible or visual alert to the driver, for example, of an object, animal or pedestrian in the path of the vehicle. In some cases, the vehicle's operating system can decelerate the vehicle automatically to avoid a collision.

Various implementations described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various modifications and combinations of the foregoing features will be readily apparent from the present description and are within the spirit of the invention. Accordingly, other implementations are within the scope of the claims.

1. A method of providing a disparity map, the method comprising:
acquiring first and second stereo images;
binarizing the first stereo image to obtain a binarized image;
applying a block matching technique to the first and second stereo images to obtain an initial disparity map, in which individual image elements are assigned a respective initial disparity value;
obtaining, for each respective image element, an updated disparity value that represents a product of the initial disparity value assigned to the image element and a value associated with the image element in the binarized image; and
generating an updated disparity map representing the updated disparity values of the image elements.

2. The method of claim 1 further including displaying on a display device the updated disparity map, wherein different disparity values are represented by different visual indicators.

3. The method of claim 2 wherein the updated disparity map is displayed as a three-dimensional color image, wherein different colors are indicative of different disparity values.

4. The method of claim 1 wherein obtaining, for each respective image element, an updated disparity value includes:
for each pixel having a value of 1 in the binarized image, assigning the initial disparity value to that pixel; and
for each pixel having a value of 0 in the binarized image, assigning a disparity value of 0 to that pixel.

5. The method of claim 1 wherein obtaining, for each respective image element, an updated disparity value includes:
for each pixel having a value of 1 in the binarized image, assigning the initial disparity value to that pixel; and
for each pixel having a value of 0 in the binarized image, assigning no disparity value to that pixel.

6. The method of claim 1 wherein the block matching technique includes:
comparing blocks of image elements in the first image to blocks of image elements in the second image; and
identifying, for each block in the first image, a respective closest matching block in the second image.

7. The method of claim 6 wherein the first and second images are of a scene, and wherein the block matching technique uses a block size that is scaled based on a size or pitch of optical features projected onto the scene.

8. The method of claim 7 wherein identifying a closest match for a particular block in the first image includes selecting a block of the second image having the lowest sum of absolute differences value with respect to the particular block.

9. An apparatus for providing a disparity map, the apparatus comprising:
first and second image capture devices to acquire, respectively, first and second stereo images;
an image binarization engine comprising one or more processors configured to binarize the first stereo image to obtain a binarized image;
a block matching engine comprising one or more processors configured to:
apply a block matching technique to the first and second stereo images to obtain an initial disparity map, in which individual image elements are assigned a respective initial disparity value;
obtain, for each respective image element, an updated disparity value that represents a product of the initial disparity value assigned to the image element and a value associated with the image element in the binarized image; and
an updated disparity map generation engine comprising one or more processors configured to generate an updated disparity map representing the updated disparity values of the image elements.

10. The apparatus of claim 9 further including a display device configured to display the updated disparity map, wherein different disparity values are represented by different visual indicators.

11. The apparatus of claim 10 wherein the display device is configured to display the updated disparity map as a three-dimensional color image, wherein different colors are indicative of different disparity values.

12. The apparatus of claim 9 wherein the block matching engine is configured such that:
for each pixel having a value of 1 in the binarized image, the initial disparity value is assigned to that pixel; and
for each pixel having a value of 0 in the binarized image, a disparity value of 0 is assigned to that pixel.

13. The apparatus of claim 9 wherein the block matching engine is configured such that:
for each pixel having a value of 1 in the binarized image, the initial disparity value is assigned to that pixel; and
for each pixel having a value of 0 in the binarized image, no disparity value is assigned to that pixel.

14. The apparatus of claim 13 wherein the block matching engine is configured to apply a block matching technique in which:
blocks of image elements in the first image are compared to blocks of image elements in the second image; and
for each block in the first image, a respective closest matching block in the second image is identified.

15. The apparatus of claim 13 including an illumination unit to project optical features onto a scene, wherein the first and second images are of the scene, and wherein the block matching engine is configured to apply a block matching technique using a block size that is scaled based on a size or pitch of the optical features projected onto the scene.

16. The apparatus of claim 14 wherein the block matching engine is configured to apply a block matching technique in which a closest match for a particular block in the first image is identified by selecting a block of the second image having the lowest sum of absolute differences value with respect to the particular block.
